(19) United States
(12) Patent Application Publication
(10) Pub. No.: US 2007/0111322 A1
(43) Pub. Date: May 17, 2007

(54) Novel method of using inject printing for creating microarrays

(76) Inventor: Lin-Cheng Yang, Yanchao (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/272,710

(22) Filed: Nov. 15, 2005

(51) Int. Cl. G01N 1/10

(52) U.S. Cl. 436/180

(57) ABSTRACT

The present invention provides a whole new method for creating high density microarrays by operating inkjet printing technology, comprising the steps of: (1) mixing solution comprising biomaterial and solvent as aqueous-based inkjet ink stock; (2) revising the control software program of inkjet printing for homologizing spreading dots and shapeliness; (3) using solid support material wherein coated with high density brushes of poly-urethane for absorption of biomaterial with low background by scanner; (4) printing said dot units contain mixing solution on solid support material; and (5) screening to identify all dot units on microarray contain biomaterial by scanner. This invention provides an user friendliness, accuracy, cost-effectiveness and improved version of simplified microarrays technology.

### BACKGROUND OF THE INVENTION

1. Field of the Invention

The invention relates to a method providing using inkjet printing as a powerful tool to create the dots of microarrays. More particularly, the invention provides the novel and conventional using of inkjet printing in manufacture microarrays. This invention combined electronic industrial and biotechnology industrial to show a novel application in microarrays.

2. Description of the Related Art

The conventional approach to drug discovery and development is a time-consuming, labor intensive, and hit-or-miss process. Microarrays promise to revolutionize disease diagnosis and drug discovery (Brown et al., 1999). With great advances in genomics, such as the completion of human genome sequencing, the next grand challenge becomes apparent: understanding biological functions of proteins encoded by genes (Espejo et al., 2002). Despite its importance, the protein microarray technology is just starting because the development of protein array is hindered by the complexity of protein molecules. Proteins are the primary structural, functional and signaling elements in the human body, thus, a comprehensive analysis of proteins is required to obtain a complete picture of normal and disease processes in the body.

Using the microarray technology, thousands of proteins or antibodies could be studied in parallel to establish their biochemical properties and biological activities (Blackstock et al., 1999). Such a high throughput analysis of protein function is essential to the biotechnology industry and human health, because most drugs we use today are either proteins or alter the functions of proteins. Specific examples may include protein microarrays for mechanistic studies of drug action, drug target, monitoring antibodies contained in serum (Belov et al., 2001; Bouwman et al., 2003) such as in the diagnostics of auto-immune diseases (Graus et al., 1997) and recombinant antibody library screening (Griffiths et al., 1994) and widely applicable in cancer research (Knezevic et al., 2001) etc.

Although such screening techniques enable antibodies or antigens to be screened against antigens or antibodies, because the dots are spread at high densities, it is difficult to identify genuine positives and isolate them from neighboring negatives. In practical terms, groups of positive dots (that correspond to the regions where a potential positive signal was observed) have to be digitilized by thousands microdots further to identify a single analogue. Furthermore, it is often difficult to repeat results from current antibody microarrays that have been used for protein expression.

Finally, such techniques are not suitable for screening against several antigens, because most of antibodies have different titer to antigen difficult to produce equal signals thus are hard to compare. This can lead to the isolation of a large number of false positives, because “sticky” or cross-reactivity cannot be excluded. However reproducible, reliable protein immobilization is being worked out by many researchers (Kersten et al., 2004).

### SUMMARY OF THE INVENTION

The invention relates to a method providing using inkjet printing as a powerful tool to create the dots of microarrays. This invention uses inkjet printing technology to develop microarrays and allow accurate printing to form functional components through additive deposition of a variety of materials in ink stock. This invention combined electronic industrial and biotechnology industrial to show a novel application creating microarrays. This invention uses inkjet printing technology to creating dots of microarrays which contain the antibodies or antigens.

One subject of the invention is to provide a method for creating microarrays by operating inkjet printing comprising the steps of:
(1) mixing solution comprising biomaterial and solvent as aqueous-based inkjet ink stock;
(2) revising the control software program of inkjet printing for homologizing spreading dots and shapeliness;
(3) using solid support material wherein coated with high density brushes of poly-urethane for absorption of biomaterial with low background by scanner;
(4) printing said dot units contain mixing solution on solid support material; and
(5) screening to identify all dot units on microarray contain biomaterial by scanner;

This invention provides a novel and pioneer method of using inject printing can resolve the limitation of conventional microarray technology.

### BRIEF DESCRIPTION OF THE DRAWINGS

The Patent or application file contains at least one drawing executed in color. Copies of this patent or patent application publication with color drawings will be provided by the Patent Office upon request and payment of the necessary fee.

FIG. 1 shows creating of high-density antibody microarrays. The density of spots in the 20 mm diameter microarrays is 2000 cm². Due to spreading of the protein solution on transparent film, the spot size is 50-100 um.

FIG. 2 shows absence of mouse antirabbit antibody used as a negative control.

FIG. 3 shows detecting for rabbit serum-binding using mouse antibody raised against rabbit. The panel depicted here consists of green labeled detection of rabbit serum proteins under low magnificent power filed (4×1)

FIG. 4 shows high power filed showed strong FITC immunofluorescence and indicated the antibody reaction to the protein.

FIG. 5 shows microarrays screening analysis of goat milk with human keratinocyte growth factor (KGF) protein.

FIG. 6 shows antibody microarrays against complex lysate antigens. Western blot analysis of melanoma cells transfected with human KGF gene. Comparison of FIG. 5 with western blot analysis.

FIG. 7 shows green fluorescent protein (GFP) immobilized on a microarray. The protein only fluoresces when it is in its native state. More importantly, GFP was immobilized from a crude preparation expressed by bacterial cells without prepurification. This result demonstrates the exceptionally high stability of our immobilization chemistry.

### DETAILED DESCRIPTION OF THE INVENTION

The invention provides a novel and pioneer method for using inkjet printing as a powerful tool to create the dots of microarray, comprising the steps of:
(1) mixing solution comprising biomaterial and solvent as aqueous-based inkjet ink stock;
(2) revising the control software program of inkjet printing for homologizing spreading dots and shapeliness;
(3) using solid support material wherein coated with high density brushes of poly-urethane for absorption of biomaterial with low background by scanner;
(4) printing said dot units contain mixing solution on solid support material; and
(5) screening to identify all dot units on microarray contain biomaterial by scanner;

Our novel method of using inject printing can solve the limitations of conventional microarray technology. Inkjet printing is one of the key technologies behind the direct writing revolution, spanning an ever-increasing number of applications.

During recent years, piezoelectric printing technology has turned academic research into a viable manufacturing solution. Modern inkjet technology allows accurate printing to form functional components through additive deposition of a variety of materials, including ceramics, conductive polymers and now, metal oxides.

Conventional enzyme-linked immunosorbent assay (ELISA) using 96-well plates or array paper would only allow a small percentage of the selected areas to be read and just like macro array detection system (Bobrow et al., 1989; Knight et al., 2004). For example, ELISA and array papers have big dots of measuring about 1 square cm in dimension. One way to increase sensitivity would be to use microdot-based assays that allow up to 20,000 dots to be simultaneously screened on a single dot. To reduce each one dot to 20,000 parts using inkjet technology to bind the antibodies or antigens. We can use this technique to bind the antigen or antibody on the transparent film in a required and limited place with increased resolution.

Using this technology, we are going to address few important questions related to speed-up, user friendliness, accuracy and cost-effectiveness and our answers will ends up with new improved version of simplified microarrays technology printing using inkjet printing.

We have also developed transparent film slides coated with high-density brushes of poly-urethane (PU). The PU brush is intrinsically inert towards the adsorption of proteins, peptides, cells, and other biomaterials, thus providing a zero background starting surface in a variety of biomedical experiments. Coating molecules in regions of PU molecules was not removed by many times washing to printing surfaces. On the other hand, standard bioconjugation chemistry may be used to covalently link biomolecules to —OH groups on the otherwise zero background PU brush.

In addition, our surface immobilization technology to preserve protein native state could provide optimal orientation for protein-target interaction. This PU coating transparent slide is more advantageous over current slides on the market. This advantage is reflected in its exceptionally low background, high uniformity, and high chemical reactivity. This method is suitable for repetitive and rapid formation of digitalized microarrays and picrospreading of proteins using inkjet printing. It demonstrates: (i) micropatterning of transparent film coating with PU gels (ii) inking of posts (diameter 50-100 um) on patterned with one or multiple (here, eight) proteins and repetitive printing. 100 times in the case of one protein and arrays (20 times in the case of eight proteins) without the need for intermediate re-inking; (iii) transferring spots of proteins with good homogeneity in surface coverage to glass slides; (iv) applying this technique to surface-based immunoassays; (v) stamping that requires only sub-nanomolar amounts of protein (typically, 3 mg in 3 mL of solution); (vi) printing without the need for drying of the proteins; and (vii) printing patterning of proteins by maximize two dots to close toward each other in an array, followed by printing the protein into a PU surface.

Additionally, protein molecules must be immobilized on a matrix in a way that preserve their native structures and are accessible to their targets. Our proteins immobilization technique in a microarrays that possess the following attributes: (1) the PU coating surface chemistry assures negligible background; (2) the proteins immobilized on the surface is embedding and controllable; (3) the immobilized proteins are in their native states and easily accessible by proteins or other molecular targets in the solution. Essentially, our proprietary coating technologies allow us to covalently attach a monolayer of molecules on a PTE surface to create functional transparent slides. Depending on the application, the functional groups on a slide can be —CHO, epoxy, —NH2, —SH etc.

The conventional method of producing proteins micorarray is too expensive, labor intensive, and time consuming. This invention make specific microarrays on site using ink-jet printing which is a simple and cost-effective high-throughput system and method for detecting the binding of chemical species with soft transparent slides and associated surface technology for protein microarray fabrication. This invention uses thin film is more advantageous over current glass slides because it transformed the analogue to digital data. This advantage is reflected in its exceptionally low background, high uniformity, and high signal to noise ratio.

DNA array technology is already used extensively as an indirect assay for protein expression by profiling mRNA expression. Because different proteins take up fluorescent or enzymes tags to different extents, labeling all proteins in a sample with a tag, as with mRNAs detected by conventional DNA microarrays, is not a viable option. To confirm whether these antibodies bind their respective antigens in e-array is workable as conventional ELISA, e-array were identical to those detected with the ELISA for HBV antibody.

We found that unlike conventional robotic procedures, that typically require ultra-thin nitrocellulose coated glass slides 3″×1″×1 mm for a limited range of binders to the target antigen, our approach using a mass spray inkjet printing enabled the proteins immobilized and shaped the array according to computer software programs. Most of these bind as soluble fragments in conventional ELISA or western blot analysis, and many also give strong signals on the recognition proteins, demonstrating their utility as immunodiagnostic methods. Even when the dilutions of the target antigens were very low (0.0005%, or 1 in 200,000), we were still able to detect specific human protein in complex KGF containing milk. Here, we have shown that this array system can be used to select binders to very rare components in a complex antigen.

According to the cheap and massive printing technology, this array could be used to isolate specific protein against a handful of proteins present in cell lysates and to separate cell to perform single cell PCR. In addition, for the array to be a truly useful tool for quantification of different proteins that the sensitivity of detection will need to be improved at least 100-fold, and perhaps a 1,000-fold compared to conventional ELISA methods.

Several strategies are now being explored to achieve high throughput selection of specific scFv. Alternatively, this printing techniques could be miniaturized enabling antigens to be used with several rounds, these proteins tended to be outcompeted with binders to other (more abundant) components of the mixture. In this regard, we wondered any source of recombinant antibodies or antibody genes cloned from immunized human must have taken place.

We believe that our novel techniques have several potential clinical and commercial advantages over conventional microarrays. These advantages may include the following: (1) faster and less expensive product development; (2) our PU immobilization preserves a protein in native state and with optimal orientation for protein target interaction; (3) our array provide high specificity for the target detection and identification; (4) This film could be applied to speed up the proteins production and purification.

A. Method and Materials

1. Ink-Jet Printing Procedure

Depending on the size of the transparent film slides with PU coating, we printed the slides in different ways. We used concentrations of 1 mg/mL of protein (rabbit serum) for the inking processing. We placed the stamp in contact with amine-modified glass slides for 2 min, and patterned 20 arrays with the same stamp without intermediate re-inking. We printed the slides with 14 points in 1 mm followed by filling the tailor made containers with different concentrations of protein solution (by repeatedly adding 20 ml of solution of protein). We used the following protein solutions: 1 mg/mL, 100 ug/mL, 10 ug/mL, and 1 ug/mL of protein (rabbit serum). The printing proteins library is based on commercial available antigens or antibodies. Inside of spots is hydrophilic and hydrophobic outline around the spots.

2. Preparation of Microarrays of Proteins for Immunoassays

Fluorescein isothiocyanate (FITC)-labeled mouse antirabbit monoclonal antibody or 15 mg/mL HRP-labeled goat antirabbit polyclonal antibody were purchased from Molecular Probes (Eugene, Oreg., USA). Incubate slides in blocking buffer overnight at 4° C. (rotate at ˜30 rpm) then put primary Ab on slides. Place slides into a tray for incubation. Put 300, 400, or 500 ml of diluted serum (test sample) on the print side directly on top of the array spots. The hydrophobic outline was done properly, then fluid will stay inside the frame. Incubate slides for 1 hour at 4° C. (rotate at ˜30 rpm).

Perform a quick rinse in old wash buffer (blocking buffer used for overnight incubation). Put slides into fresh wash buffer and place on shaker platform for 15 minutes at ˜40 rpm. Repeat previous step then put secondary Ab on slides. Place slides into a tray for incubation, print side up. Put 300, 400, or 500 ml of diluted secondary Ab (fluorescent marker) on the print side directly over the array spots. The fluorescent marker is photosensitive so cover with Al foil during the incubation to prevent photo bleaching. Incubate slides for 45 minutes at 4° C. (rotate at 30 rpm). Perform a quick rinse in previous wash buffer. Put slides into fresh wash buffer and place on shaker platform for 30 minutes at ˜40 rpm. Repeat previous step. Put slides into 1×PBS and place on shaker platform for 20 minutes at ˜40 rpm. Repeat previous step. Put slides into ddH2O and shake for 15 seconds. Repeat previous step and centrifuge to dry slides. Spin at 650-750 rpm for 8 minutes at 25° C. (make sure centrifuge is balanced). Put slides into slide box and store at 25° C. (slides are ready to be scanned).

3. Western Blotting

Samples were kept frozen on dry ice and stored at −70° C. The tissue was defrosted, weighed and then homogenized using a polytron tissue homogenizer (1 min) in phosphate buffered saline (PBS) containing 34 mg/l bacitracin, Complete™ protease inhibitors (Boehringer Mannheim, Indianapolis, Ind.) and phosphatase inhibitors (1 mM sodium vanadate; 20 mM sodium fluoride). Samples were centrifuged (3000 g, 15 min at 4° C.), and an aliquot (1 ml) was removed, lyophilized and stored at −20° C. until further processing. Western blot analysis was performed on RIPA lysates (20 μg per lane), which were electrophoresed in 10% sodium dodecyl sulphate-polyacrylamide electrophoresis gels, and proteins were analyzed by enhanced chemiluminescence Western blotting (Amersham, Arlington Heights, Ill.). Antibodies used were polyclonal antibodies against rabbit serum (1:500), which were purchased from Santa Cruz Biotechnology (Santa Cruz, Calif., USA). An antibody against α-tubulin was used as a loading control.

4. ELISA System to Determine Serum Antigens

To test whether differences in our array and conventional ELISA protocols, conventional ELISAs were performed. 96-well ELISA plates were coated overnight at 4° C. using 10 μg/ml purified antigens or 100 μg/ml (total protein concentration) unpurified recombinant bacterial lysates. Reducing conditions included addition of antioxidant (Invitrogen) to running buffer and transfer buffer to prevent oxidation of reduced cysteine, methionine and tryptophan residues. Blots were incubated overnight with a biotinylated Hepatitis B specific, affinity purified, antibody (Biorad Systems) at 1:1000 dilution overnight at 4 oC. PEDF antigen was immunoprecipitated using agarose-immobilized ELISA capture mAb. For immunoprecipitation studies, 2 ml of serum was first cleared of contaminating IgG by passage through a Protein G column (Pierce) and 1 ml PBS fractions collected. The eluted fraction with the highest protein content was batch incubated with 200 μl immobilized capture mAb (200 μg PEDF Ab per 100 μl of packed resin) overnight with continuous rocking at 4 oC. Following overnight incubation the agarose resin was transferred to a spin column, proteins that did not stick were collected, and the column washed with 5, 1 ml PBS washes. The bound proteins were eluted and proteins in all fractions separated under denaturing and reducing conditions on 4-12% NuPAGE Bis-Tris gels, and then transferred to Invitrolon membranes following the manufacturer's protocols (Invitrogen). In some instances, fractions with low total protein content were first concentrated 800 fold (Eppendorf vacuum concentrator, Westbury, N.Y.). In all instances, PEDF Western blots were performed using a polyclonal biotinylated antibody at 1:1000 dilution followed by strepavidin-horseradish peroxidase conjugate used at a 1:500 dilution (R&D Systems). Antibody specific bands were detected using a chemiluminescent substrate (Pierce) and bands quantified. Data are expressed as net intensity values normalized to the staining intensity of a recombinant PEDF standard (7.5 ng).

For this step, we diluted the original solutions of the primary antibodies from the supplier (see below) five-to tenfold in PBS, except for the anti-ubiquitin antibody, which we used undiluted. We purchased the monoclonal mouse anti-ubiquitin antibody (IgG1, kappa), the monoclonal mouse anti-myoglobin antibody (IgG1) and the rabbit anti-lysozyme antibody from Zymed Laboratories (San Francisco, Calif., USA). The anti-BSA antibody was from Sigma and the anti-ovalbumin antibody from Biodesign International (Saco, Me., USA; we used this antibody at a concentration of 1 mg/mL in PBS). After incubation of the slides overnight at 47 C in the solutions containing the primary antibodies, we washed all slides thoroughly with PBS. In order to detect bound primary antibodies from the first incubation step, we incubated the slides with rhodamine-labeled secondary antibodies (from Zymed Laboratories). We immersed those slides that we incubated in the first step with primary antibodies from mouse with a solution of a TRITC-labeled, secondary, anti-mouse antibody from goat, and those slides that we incubated in the first step with a primary antibody from rabbit with a solution of TRITC-labeled, secondary, anti-rabbit antibody from goat. We used 0.15 mg/mL concentrations of these secondary antibodies in PBS and we incubated the slides overnight at 47C. We washed the slides with PBS followed by a brief wash with deionized water before drying in a stream of nitrogen, or we left the slides under PBS buffer before microscopic observation.

5. Instructions for Scanning Microarrays

After probing the array slides with samples, one is now ready to scan them.

To scan a microarrays slide is too convert the biological information trapped on the slide into digital information for data analysis.

The act of scanning involves using a laser to excite the fluorescent markers on either the antigens or secondary antibodies and detecting the intensity of the fluorescence given off by these markers after being excited.

The fluorescent intensity given off by the markers is dependent on three things

1) the number of markers present

2) the power of the excitation laser

3) the setting on the detector PMT.

Signal producing system (“sps”): one or more components, at least one component being a label, which generate a detectable signal that relates to the amount of bound and/or unbound label, i.e. the amount of label bound or not bound to the compound being detected. The label is any molecule that produces or can be induced to produce a signal, such as a fluorescer, enzyme, chemiluminescer or photosensitizer. Thus, the signal is detected and/or measured by detecting enzyme activity, luminescence or light absorbance. Suitable labels include, by way of illustration and not limitation, enzymes such as alkaline phosphatase, glucose-6-phosphate dehydrogenase (“G6PDH”) and horseradish peroxidase; ribozyme; a substrate for a replicase such as Q-beta replicase; promoters; dyes; fluorescers such as fluorescein, isothiocyanate, rhodamine compounds, phycoerythrin, phycocyanin, allophycocyanin, o-phthaldehyde, and fluorescamine; chemiluminescers such as isoluminol; sensitizers; coenzymes; enzyme substrates; photosensitizers; particles such as latex or carbon particles; suspendable particles; metal sol; crystallite; liposomes; cells, etc., which can be further labeled with a dye, catalyst or other detectable group. Suitable enzymes and coenzymes are disclosed in Litman, et al., U.S. Pat. No. 4,275,149, columns 19-28, and Boguslaski, et al., U.S. Pat. No. 4,318,980, columns 10-14; suitable fluorescers and chemiluminescers are disclosed in Litman, et al., U.S. Pat. No. 4,275,149, at columns 30 and 31; which are incorporated herein by reference. Preferably, at least one sps member is selected from the group consisting of fluorescers, enzymes, chemiluminescers, photosensitizers and suspendable particles.

B. Results

1. Creation of High-Density Antibody Microarray

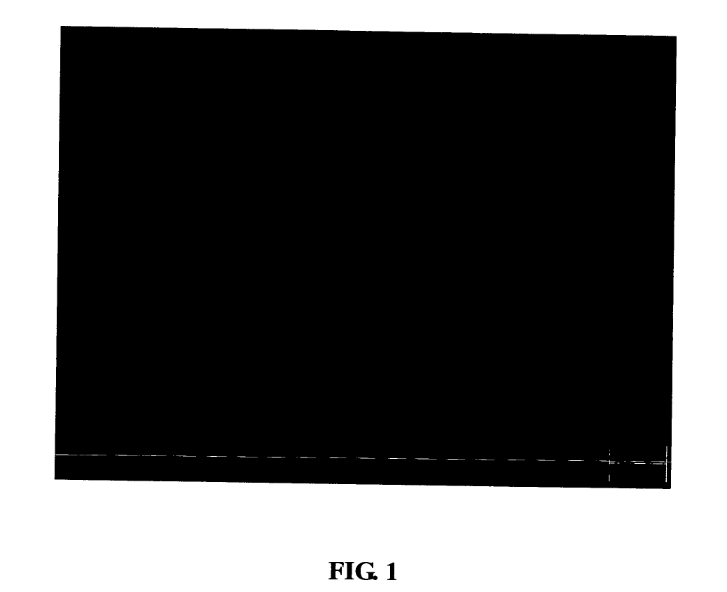

We inked the transparent film slides with 2 cm diameter individually with a different protein by inkjet printing, 2 mL of a solution of protein (typically at a concentration of 1 mg/mL in deionized water or PBS) onto the antibody container for gradients of proteins. Photographs showed the micrographs of patterns of proteins obtained by conventional printer. (A). The density of spots in the 20 mm diameter array is 2000 dots/cm². Due to spreading of the protein solution on transparent film, the spot size is 50-100 um (FIG. 1).

2. Fluorescence Microscopy Images of Protein Microarrays Printed on PU Coating Low Background Slides.

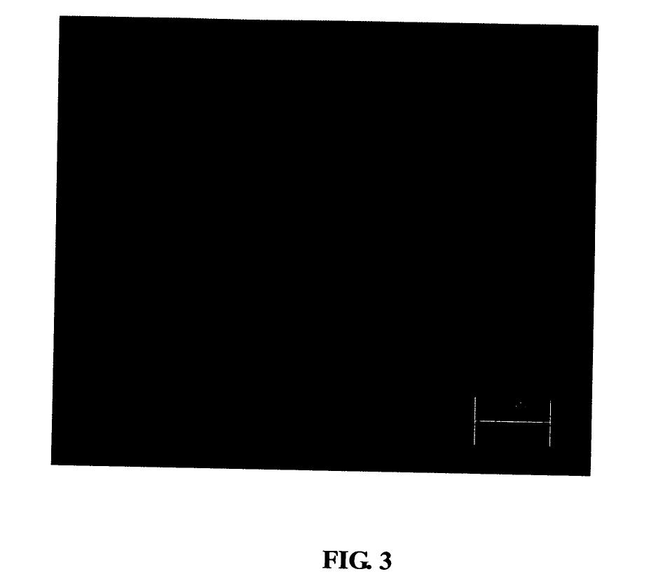

We compared the signals derived by direct capture of mouse antibody labeling FITC raised against rabbit on rabbit antigen-coated transparent film. We found that direct capture on antigen gave a consistently higher signal-to-noise ratio (FIG. 3). Furthermore, coating the antigen on the PU coating film removes the need of bioconjuation, which is time consuming and can be difficult for certain antigens. Green and red labeled detection of serum proteins indicated the antibody reaction to the protein

3. Microarray Screening Versus Conventional Selection and ELISA Screening.

To compare the utility of a mass array screen following a single round of microarray to a conventional ELISA assay, purified rabbit serum IgG was used as an antigen for printing dose selection, either undiluted or diluted to different concentrations. After comparison, 2 pg/mL for rabbit serum could be detected by conventional ELISA. However, when compared with the e-array technique, no rabbit serum was identified by the conventional method even though 200 times more antirabbit antibody was used. In contrast, after a single round of selection the e-array method yielded specific binding for all dilutions, including 0.1 pg/ml. Of these assays, mouse antirabbit antibodies were confirmed to bind strongly to 0.1 pg/mL rabbit serum but were negative using an irrelevant bacterial lysate as the antigen.

4. Comparison of Microarrays Screening with Western Blot Analysis

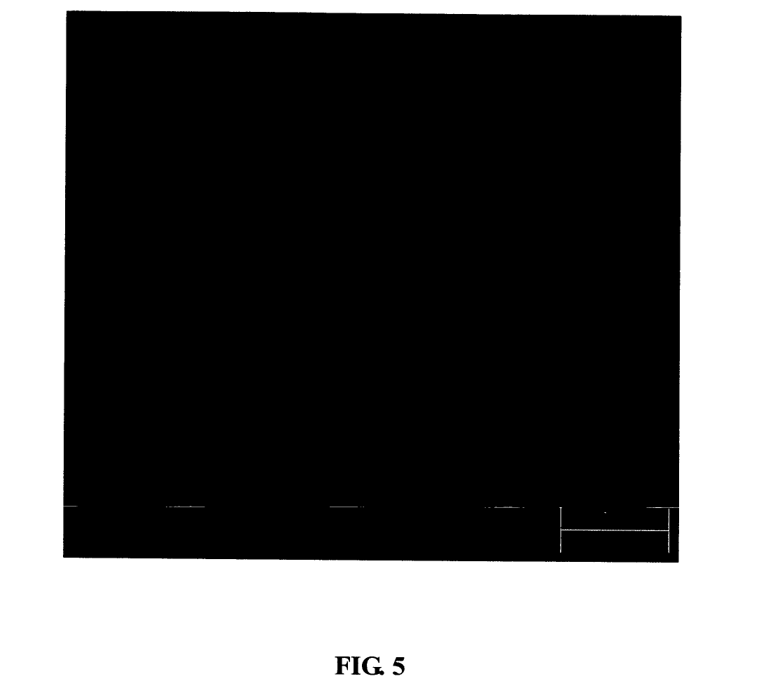

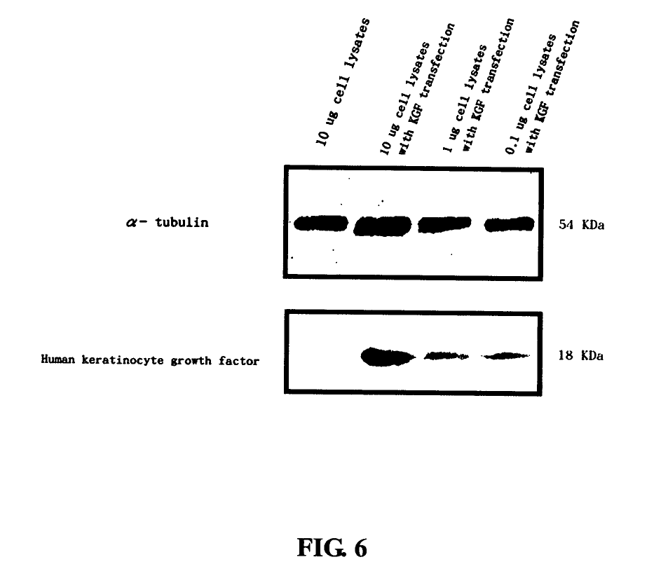

Microarrays (FIG. 5) and Western blotting (FIG. 6) and were performed, and all gave strong and positively correlated signals, demonstrating high binding specificity. Our success in selecting antibodies against dilute components in complex protein mixtures suggested that the same procedure could be used to select antibodies against targets present in natural proteins. Furthermore, using e-arrays it should be possible to identify proteins that are differentially expressed between species. Why so few human keratinocyte growth factor (KGF)-specific binding regions were confirmed is almost certainly because of the e-array specificity, where the affinities compared with ELISA-based or western blot-based assays are much higher. Thus, very low concentrations of antibodies can be used to select binding antigens (down to 0.0005%). Consequently, it is likely that antibodies against many targets in the milk were in fact selected but that only those that bound targets could be detected.

The following Examples are given for the purpose of illustration only and are not intended to limit the scope of the present invention.

### SAMPLE 1

### Fluorescence Microscopy Images of Protein Arrays Printed on PU-Coated Low Background Slides (FIG. 1).

We compared the signals derived by direct capture of rabbit antimouse antibodies labeled with fluorescein isothiocyanate (FITC) on rabbit antigen-coated transparent film. We found that direct capture on the antigen gave a consistently higher signal-to-noise ratio. Furthermore, coating the antigen on the PU coating film removes the need of bioconjugation, which is time consuming and can be difficult for certain antigens. Green (FITC)— and red (Rhodamine)-labeled detection of serum proteins indicated antibody-binding reactions.

### SAMPLE 3

### Detection of Rabbit Serum Binding Using Mouse Antirabbit Antibodies

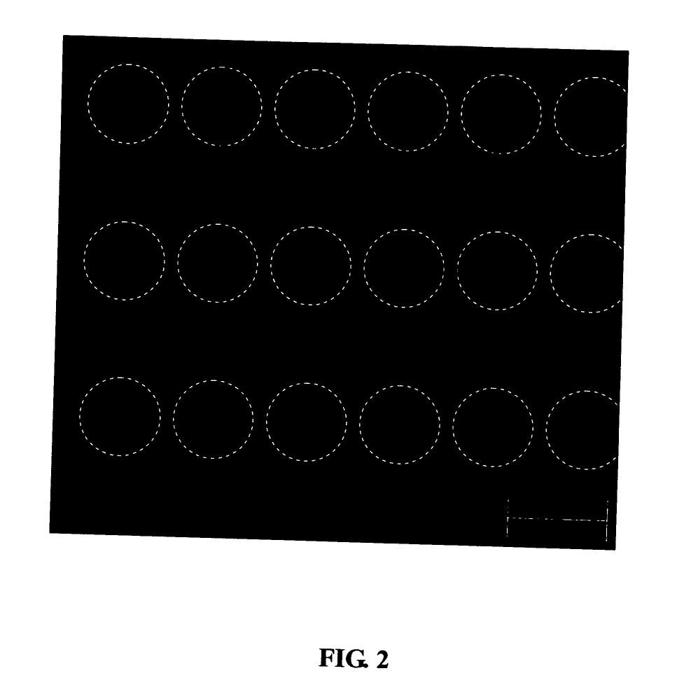

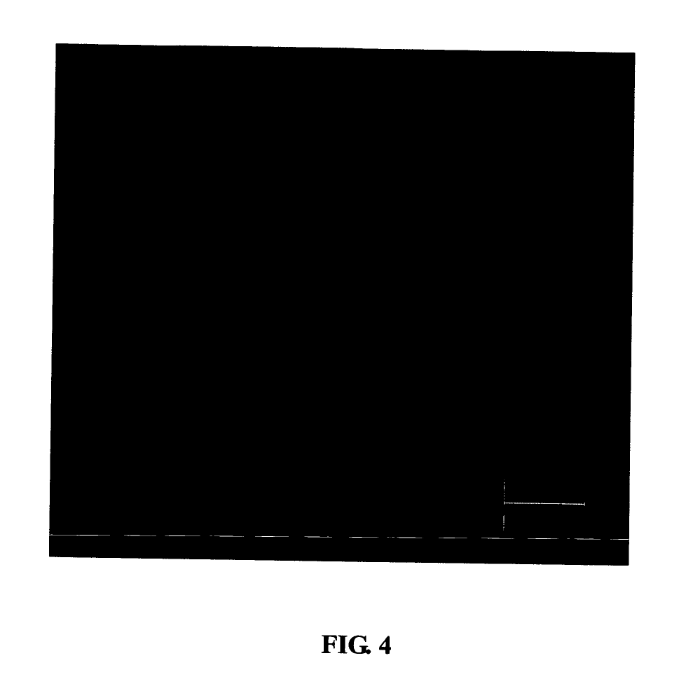

FIG. 3 and FIG. 4 clearly indicates that functional plastic slides using mouse antibody raised against rabbit made with our coating technology yielded much lower background (FIG. 2) and produced sharper images. In addition, spot diffusion is minimal with our slides.

### EXAMPLE 4

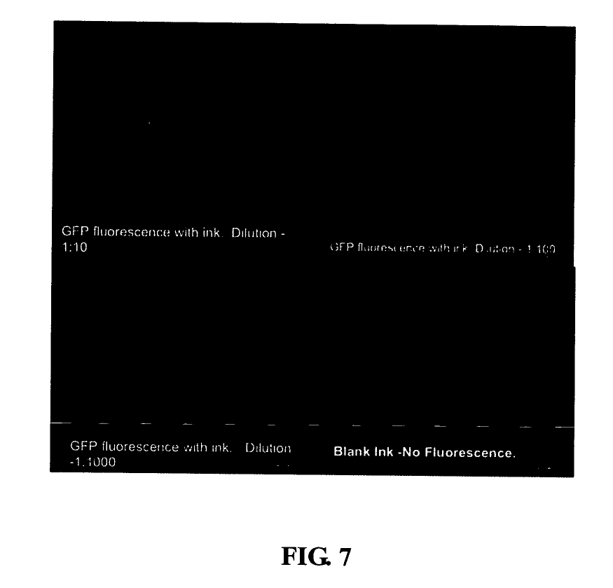

### Shows Green Fluorescent Protein (GFP) Immobilized on a Microarrays (FIG. 7).

The protein only fluoresces when it is in its native state. More importantly, GFP was immobilized from a crude preparation expressed by bacterial cells without prepurification. This result demonstrates the exceptionally high stability of our immobilization chemistry.

### EXAMPLE 5

### Existing Methods for Manufacturing Micro-Arrays are Complex and Expensive

As a result, this inkjet printing for microarray is a simple and cost-effective high-throughput system and method for detecting the binding of chemical species is compatible with commercial scanners applications.

It is intended that the present invention is not limited to the particular forms as illustrated, and that all the modifications not departing from the spirit and scope of the present invention are within the scope as defined in the appended claims.

What is claimed is:

1. A method of producing a digital microarray by operating of an inkjet printing apparatus, comprising the steps of:
(1) mixing solution comprising biomaterial and solvent as aqueous-based inkjet ink stock;
(2) revising the control software program of inkjet printing for homologizing spreading dots and shapeliness;
(3) using solid support material wherein coated with high density brushes of poly-urethane for absorption of biomaterial with low background by biosensor;
(4) printing said dot units contain mixing solution on solid support material; and
(5) screening to identify all dot units on microarray contain biomaterial by scanner;

2. The method of claim 1, wherein the biomaterial is protein or DNA fragment.

3. The method of claim 2, wherein the protein is antibody or antigen.

4. The method of claim 3, wherein the protein is antibody.

5. The method of claim 3, wherein the protein is antigen.

6. The method of claim 1, wherein the dot size is between 50 and 100 um.

7. The method of claim 1, wherein the biomaterial is conjugated fluorescence agent, nano-particle or magnetic bead.

8. The method of claim 7, wherein the fluorescence agent is FITC

9. The method of claim 7, wherein the fluorescence agent is Cy5.

10. The method of claim 7, wherein the fluorescence agent is Cy3.

11. The method of claim 1, wherein the method comprises immobilizing a biomaterial on the surface of the solid support material.

12. The method of claim 11, wherein the poly-urethane is used to covalently link protein to —OH group and preserve protein native state with optimal orientation for protein target interaction.

13. The method of claim 11, wherein the biomaterial is attached monolayer of molecules on the surface of the solid support material to identify different other biomaterial with covalently binding by —CHO, epoxy, —NH2, SH group.

14. The method of claim 1, wherein the solvent is an aqueous solution for adjusting viscosity and/or composition as ink stock.

15. The solvent of claim 1, wherein the solvent is comprising ceramics, conductive polymers and metal oxides.

16. The method of claim 1, wherein the solid support material is glass or thin film.

17. The method of claim 16, wherein the thin film is transparent film.

18. The method of claim 1, wherein the biosensor is laser scanner.
